(19) United States
(12) Patent Application Publication
(10) Pub. No.: US 2017/0069074 A1
(43) Pub. Date: Mar. 9, 2017

(54) Apparatus for Adjustably Positioning an Object of Interest

(71) Applicants: Geert M. Milis, Testelt (BE); Vincent I. Campbell, Pasco, WA (US); Brian Howton, College Place, WA (US); Phillip L. Hoffman, Walla Walla, WA (US)

(72) Inventors: Geert M. Milis, Testelt (BE); Vincent I. Campbell, Pasco, WA (US); Brian Howton, College Place, WA (US); Phillip L. Hoffman, Walla Walla, WA (US)

(73) Assignee: KEY TECHNOLOGY, INC., Walla Walla, WA (US)

(21) Appl. No.: 14/848,717

(22) Filed: Sep. 9, 2015

(51) Int. Cl. G06T 7/00; G06T 7/20; H04N 7/18; H04N 5/225; B65G 23/44; B65G 43/02

(52) U.S. Cl. CPC G06T 7/0004; B65G 23/44; B65G 43/02; H04N 7/18; H04N 5/2251; G06T 7/004; G06T 7/20; G06T 7/0085; G06T 2207/30164

(57) ABSTRACT

An apparatus for adjustably positioning an object of interest is described, and which includes an imaging device which is mounted in spaced relation to an object of interest, and which further forms an image of a feature of the object of interest during operation; an adjustment device mounted in force transmitting relation relative to the object of interest an which imparts force to the object of interest to maintain the object of interest along a course of travel; and a controller coupled in controlling relation relative to the adjustment device, and in signal receiving relation relative to the imaging device.

### TECHNICAL FIELD

The present invention relates to an apparatus for adjustably positioning an object of interest, and more specifically to a device which is peculiarly adapted to visualize and then adjustably maintain the edge of a continuous conveyor belt in a predetermined location as it rotates between a drive roller, and an idler roller, respectively.

### BACKGROUND OF THE INVENTION

The use of continuous conveyor belts to transport products between work stations, have been extensively used since the industrial revolution. The construction of these continuous conveyor belts are well known. In their simplest form the conventional conveyor belts include a drive roller which is coupled to some energizing force such as an electric motor, or the like, and which further rotates the drive roller in a given direction, Spaced a given distance from the drive roller is an idler roller. The continuous conveyor belt is tensioned between the drive roller, and the idler roller, Rotation of the drive roller imparts motion to the conveyor belt which then travels and moves about the idler roller and then returns to the drive roller, The upper facing surface or top flight of the conveyor belt supports a product or objects that need to be transported along the upper flight of the conveyor belt.

At relatively low operational speeds, the continuous conveyor belt typically rotates and stays oriented along a given path of travel between the drive roller, and idler roller during operation. However, as rotational speeds and conveyor belt speeds have increased, it has long been recognized that the continuous conveyor belts can migrate, creep or otherwise move from side-to-side. This side-to-side movement increases the wear on the conveyor belt because of increased friction. Often this side-to-side migration or creeping is caused by numerous factors including bearing wear which causes the respective axles supporting the drive roller, and the idler roller, to become misaligned or otherwise located in an unparallel relationship thus causing or encouraging the conveyor belt to migrate to one side or the other of the respective rollers. In other instances, the mere wear of the conveyor belt due to its continuous usage with a given product causes the conveyor belt to wear, unevenly, and thus migration results. Still, in other instances, the high speed of rotation of the conveyor belt may cause the belt to unduly vibrate during operation. This motion, again, encourages migration of the conveyor belt in one direction, or another. Yet further, and while the drive roller, and idler roller may be maintained in a substantially parallel relationship, the non-horizontal orientation of the conveyor assembly, as a whole, can encourage migration or creeping of the rotating conveyor belt in one direction, or side of the conveyor assembly, or another.

Once this motion of the conveyor belt is observed, adjustments can be made to either the drive or idler rollers so as to encourage the continuous conveyor belt to move back to an appropriate orientation relative to the drive and idler rollers. However, this adjustment to the respective drive or idler roller is normally done, by hand, and requires some degree of expertise, in order to effect the appropriate adjustment which is necessary to cause the continuous conveyor belt to move back to an appropriate orientation relative to the drive and idler rollers, respectively. For particularly long and continuous conveyor belts, this adjustment process may take some period of time, and may further, on occasion, cause the conveyor assembly to be taken out of service while the adjustments are being made. Obviously, the failure to make the appropriate adjustments to the drive or idler rollers may result in a premature wearing of the conveyor belt, or perhaps even a catastrophic failure of the conveyor belt, depending upon the type of conveyor belt being employed.

An apparatus for adjustably positioning an object of interest such as a rotating conveyor belt, is the subject matter of the present Application.

### SUMMARY OF THE INVENTION

A first aspect of the present invention relates to an apparatus for adjustably positioning an object of interest which includes, an object of interest which, when rendered operational, is moveable along a predetermined course of travel; an imaging device which is mounted in spaced relation relative to the object of interest, and which forms an image of a feature of the object of interest, and wherein the imaging device forms an image signal of the feature which is imaged; an adjustment device mounted in force transmitting relation relative to the object of interest, and wherein the adjustment device, when actuated, imparts force to the object of interest to maintain the object of interest along the course of travel; and a controller coupled in image signal receiving relation relative to the imaging device, and which is further disposed in controlling relation relative to the adjustment device, and wherein the controller selectively actuates the adjustment device based upon the received image signal so as to maintain the movement of the object of interest along the predetermined course of travel.

Still another aspect of the present invention relates to an apparatus for adjustably positioning an object of interest which includes, an elongated, continuously rotatable conveyor belt which has opposite first and second ends, a top flight for supporting a product, and an opposite bottom flight, and wherein the elongated, continuously rotatable conveyor belt has a peripheral edge, and is further tensioned between a drive roller, and at least one idler roller, and further has a longitudinal axis which extends between the first and second ends thereof, and wherein the drive roller, and the at least one idler roller, each have a longitudinal axis which is located in a transverse orientation relative to the longitudinal axis of the elongated, continuously rotatable conveyor belt; an electromagnetic radiation emitter which, when energized, emits electromagnetic radiation which is directed towards the peripheral edge of the top or bottom flight of the elongated, continuously rotatable conveyor belt; a linear actuator mounted in force transmitting relation relative to the drive roller and/or idler roller, and wherein a force generated by the linear actuator on either of the drive roller and/or idler roller changes the orientation of the longitudinal axis of either of the drive roller and/or idler roller relative to the longitudinal axis of the elongated, continuously rotatable conveyor belt; an imaging device which is mounted in spaced relation relative to the top or bottom flight of the elongated, continuous conveyor belt, and wherein the imaging device forms an image of the peripheral edge of the top or bottom flight from at least some of the electromagnetic radiation which is directed toward the peripheral edge by the energized electromagnetic radiation emitter, and wherein the imaging device forms an image signal which is representative of the image of the peripheral edge, and which is formed by the imaging device; and a controller coupled in image signal receiving relation relative to the imaging device, and which is further controllably coupled with each of the linear actuator, and the electromagnetic radiation emitter, and wherein the elongated, continuous conveyor belt is moveable along a predetermined path of travel between the drive roller, and the at least one idler roller, and wherein the controller, upon sensing from the received image signal that the peripheral edge of the top or bottom flight is moving in a direction which is away from the predetermined path of travel, operably actuates the linear actuator so as to exert a predetermined amount of force on either the drive roller and/or idler roller, so as to affect a change in the positional orientation of the longitudinal axis of the drive roller and/or the idler roller relative to the longitudinal axis of the elongated, continuous conveyor belt, and, further causes a resulting motion of the elongated, continuous conveyor belt in a direction back to and along the predetermined path of travel.

These and other aspects of the present invention will be discussed in greater detail hereinafter.

### BRIEF DESCRIPTION OF THE DRAWINGS

Preferred embodiments of the invention are described, below, with reference to the following accompanying drawings;

FIG. 1 is a greatly simplified, schematic, side elevation view of a first form of the present invention.

FIG. 2 is a greatly simplified, schematic, side elevation view of a second form of the present invention.

FIG. 3 is a greatly simplified, schematic view of a third form of the present invention.

FIG. 4 is a greatly simplified, schematic, top plan view, of one of the forms of the present invention.

### DETAILED DESCRIPTION OF THE PREFERRED EMBODIMENT

This disclosure of the invention is submitted in furtherance of the constitutional purposes of the U.S. Patent Laws “to promote the progress of science and the useful arts” [Art. I, Sec. 8].

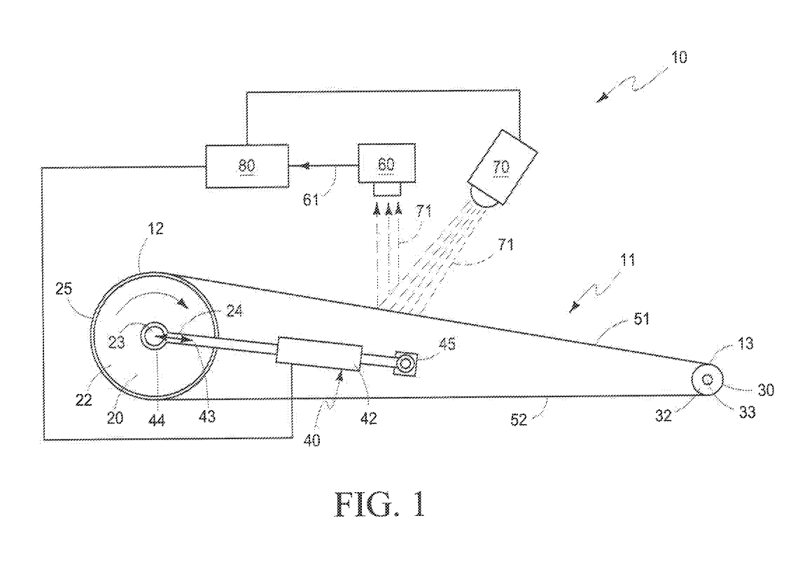

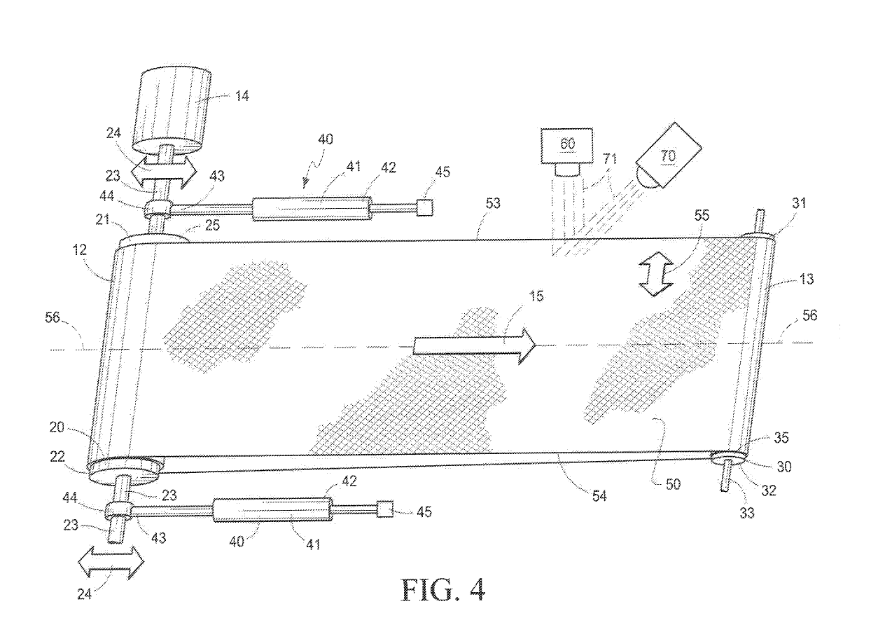

An apparatus for adjustably positioning an object of interest is generally indicated by the number 10, in FIG. 1, and following. As seen in the drawings, the present apparatus 10 is peculiarly designed for adjustingly positioning an object of interest, here indicated by the numeral 11, and which is depicted as a continuous conveyor belt assembly for transporting various individual objects (not shown). The continuous conveyor belt assembly 11 has an intake end 12, and an opposite discharge or exhaust end which is generally indicated by the numeral 13. As seen in FIG. 4, the object of interest or continuous conveyor belt assembly 11 is rendered operable for movement by a selectively energizable motor of traditional design. Typically, continuous conveyor belt assemblies are energized by electric motors. However motors driven by other power sources would work with an equal degree of success. As seen in FIG. 4 the motor 14 is operable to drive the continuous conveyor belt assembly 11 so that it moves along a predetermined course of travel which is generally indicated by the arrow labeled 15. The course of travel 15 extends from the intake end 12, to the exhaust end 13, thereof.

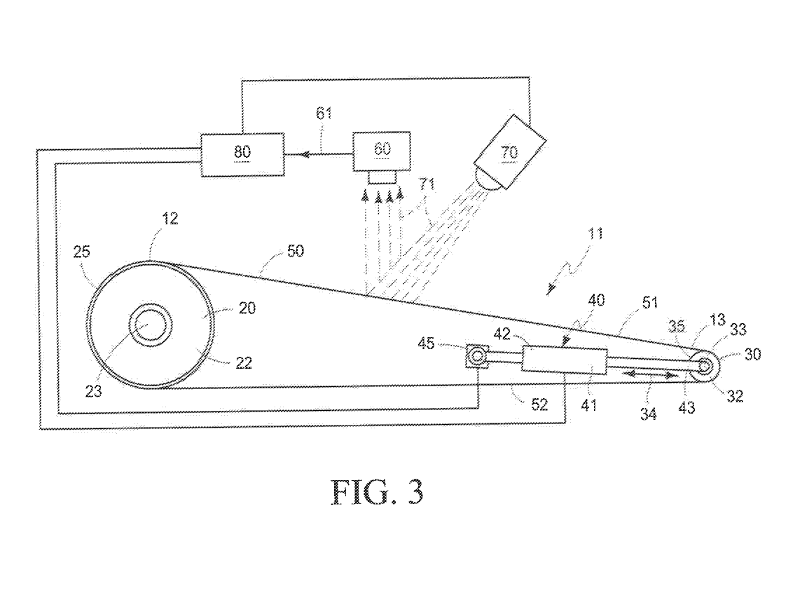

The continuous conveyor belt assembly or object of interest 11 includes a drive roller 20 as seen in FIG. 1, and following. The drive roller 20 has opposite first and second ends 21 and 22, respectively, and further is rotatable about a centrally disposed axle 23. The axle 23 is held in a given orientation and is rendered rotatable by means of bearings which are held in bearing blocks, not shown. It should be understood that at least one, or perhaps both, of the bearing blocks supporting the axle 23 are reciprocally moveable along a given linear path of movement which is generally indicated by the numeral 24. The drive roller 20 has an exterior facing surface 25 which frictionally engages an overlying conveyor belt which will be discussed in the paragraphs which follow. The continuous conveyor belt assembly 11 further includes an idler roller 30 which is located in a predetermined, spaced relationship relative to the drive roller 20. The idler roller is of traditional design, and has opposite first and second ends 31 and 32, respectively, and an axle 33 which rotatably supports the idler roller in a predetermined, substantially parallel, spaced relationship relative to the drive roller 20. Again, the first and second ends 31 and 32 of the idler roller 30 are mounted within bearing blocks, not shown. The bearing blocks, in one form of the invention, can be rendered moveable along a given path of movement 34, as seen in FIG. 3. Again, the idler roller 35 has an exterior facing surface 35 which frictionally and operably engages an overlying and flexible conveyor belt which will be discussed in the paragraphs which follow.

The present invention 10 includes an adjustment device which is mounted in force transmitting relation relative to the object of interest, here illustrated as the continuous conveyor belt assembly 11, and which, when actuated, imparts force to the object of interest 11 to maintain the object of interest along the course of travel 15. In this regard, the adjustment device 40 is herein illustrated as a linear actuator 41 which could be in the form of a screw-thread type, or a fluid actuated cylinder of traditional design. In this regard, the linear actuator 41 has a first end 42, and an opposite second end 43. The second end 43 has an axle engagement member 44 which matingly, and forcibly cooperates with the first end 21, of the drive roller 20, or the first end 31, of the idler roller 30, depending upon the form of the invention being considered. While the invention 10 is illustrated in FIGS. 1, 2 and 3 as having an adjustment device 40 on only one side of the continuous conveyor assembly 11, it will be seen by a study of FIG. 4 that the present invention 10 could be arranged, so as to have two adjustment devices 40, which are individually located on opposite sides of the continuous conveyor assembly 11, so as to move the drive roller 20, or the idler roller 30, along their respective linear paths movement 24 or 34, respectively, in order to change their relative spatial orientation with respect to the opposite drive or idler roller. By changing the relative orientation of the respective drive or idler rollers in small increments, the continuous conveyor belt, as will be discussed, below, can be operably maintained along the predetermined course of travel 15. This further prevents the continuous conveyor belt, as will be described, from drifting to either side, or in the direction of either the opposite, first or second ends of the drive roller 20, or idler roller 30, respectively. The adjustment device 40 further includes a load cell 45 which is operable to determine the amount of force that the linear actuator 41 is exerting on, or against, the respective axles 23 or 33, respectively. This load cell 45 generates an important electrical signal which contains information relating to the amount of force being exerted on the continuous conveyor belt so that adjustments can be made within a range of force values which are appropriate for the type of continuous conveyor belt which is being utilized in connection with the present invention 10.

The object of interest and which is herein depicted as a continuous conveyor belt assembly 11, has a rotatable and flexible conveyor belt and which is generally indicated by the numeral 50. The conveyor belt 50 is tensioned between the drive rover 20, and idler roller 30, so that it may remain in force receiving relation relative to the drive roller 20. The conveyor belt 50 has a top flight 51, and an opposite, bottom flight labeled 52. The top flight 51 is operable to support a product or other item of interest and which is being transported along the predetermined course of travel 15 and between the intake end 12, and the exhaust end 13. As seen by reference to FIG. 4, the continuous conveyor belt 50, and more specifically the top or bottom flights 51 or 52 thereof, each has a first or left peripheral edge 53, and an opposite, second or right peripheral edge 54. As can be seen from that same drawing, the continuous conveyor belt 50 when rendered operational, may move along a transversely oriented path of travel which is indicated by the numeral 55, in a slowly drifting fashion or change in the orientation, either toward the left of the predetermined course of travel 15, or to the right thereof. Again, this drifting or change in the orientation of the conveyor belt 50 relative to the idler roller 30, may be caused by belt wear; speed of operation of the belt; or from the idler roller 30, and drive roller 20 moving into an unparallel orientation, one relative to the other. Still further, and if employed in an optical sorting device of the type and which inspects a stream of a product while it is traveling along a free-fall path of travel after leaving the top-flight of the conveyor belt 50, (not shown) the drifting motion of the conveyor belt 50 can cause the object or product to be inspected to travel along a somewhat unpredictable path of travel or trajectory. In this undesirable situation, the optical sorting apparatus may malfunction because a previously identified defective or undesirable product or object might not be effectively ejected from the free-falling product stream because the attempt to eject the defective object or product takes place in the wrong location along the assumed trajectory of the free-falling object or product which is being sorted.

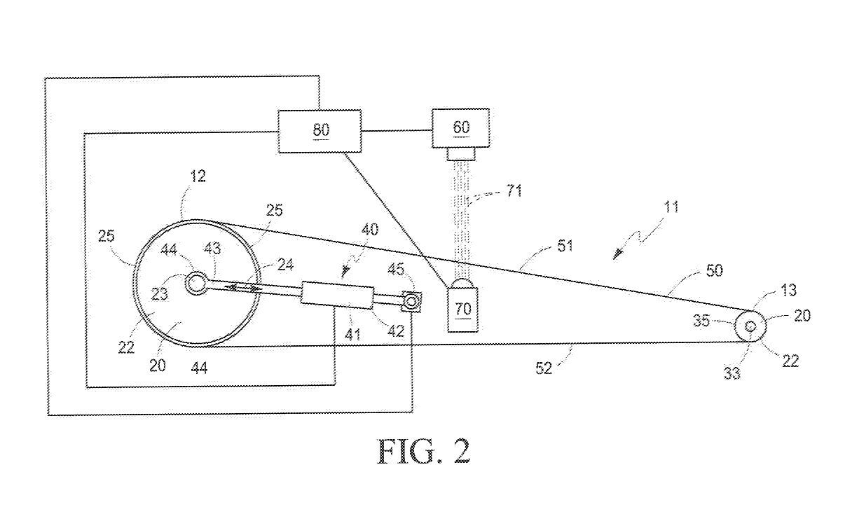

The prevent invention 10 includes an imaging device which his generally indicated by the numeral 60 and which is further mounted in spaced relation relative to the object of interest 11. The imaging device 60, when rendered operational, forms an image of a feature of the object of interest, For purposes of illustration, the feature being imaged is seen and discussed hereinafter as either the left or right peripheral edge 53 or 54, of the top or bottom flight 51 or 52, of the continuous conveyor belt 50, In the present invention 10 the imaging device 60 forms an image signal 61 of the feature which is imagined. The apparatus 10 of the present invention further includes an electromagnetic radiation emitter 70 which emits electromagnetic radiation 71, and which further forms, at least in part, a portion of the image generated by the imaging device 60, and which is formed into the image signal 61, It should be understood that the emitted electromagnetic radiation 71 may be either visible, or invisible. In one form of the invention the electromagnetic radiation emitter 70 emits electromagnetic radiation 71 in a manner, and wherein, the electromagnetic radiation 71 is transmitted in a direction from the continuous conveyor belt 50, and in the direction of the imaging device (FIG. 2). In another form of the invention, (FIG. 1) the electromagnetic radiation emitter 70 emits electromagnetic radiation 71 in a manner and where the electromagnetic radiation is transmitted in a direction toward, and is reflected at least in part from, the object of interest 11. In this arrangement, at least some of the reflected electromagnetic radiation 71 forms the image generated by the imaging device 60, and which is transformed into an image signal 61.

The apparatus 10 further includes a controller which is coupled in image signal receiving relation relative to the imaging device 60, and which is further disposed in controlling relation relative to the adjustment device 40. The controller 80 selectively actuates the adjustment device 40, based upon the received image signal 61, so as to maintain the movement of the object of interest 11 along the predetermined course of travel 15. The controller 80 is operably coupled to each of the linear actuator 41; load cell 45; imaging device 60; and electromagnetic radiation emitter 70 so as to selectively actuate the respective components in a coordinated fashion, and thus monitor the position of the feature being imaged, that being the first or second peripheral edges of the top or bottom flights 51 or 52, of the conveyor belt 50, and thereafter provides signals based upon the image signal 61 which is received, so that the linear actuator 41 exerts sufficient force on either of the respective drive roller 20, or idler roller 30. This exerted force encourages the movement of these assemblies, and thus a corresponding and resulting movement of the conveyor belt 50 along the path of belt drift 55. Thus at least one of the linear actuators 41 is operable to cause a subsequent movement of the continuous conveyor belt 50 from a displaced position relative to the path of travel 15, back into alignment with the path of travel. This adjustment of the conveyor belt 50 ensures that objects being transported by the conveyor belt 50, and which are released to move along a free-fall path of travel or trajectory move along a predictable and consistent free-fall path of travel.

### OPERATION

The operation of the described embodiment of the present invention 10 is believed to be readily apparent and is briefly summarized at this point.

In its broadest aspect, the present invention relates to an apparatus 10 for adjustably positioning an object of interest 11, and where the object of interest 11, such as a conveyor belt 50, is rendered operable to move along a predetermined course of travel 15. The invention 10 further includes an imaging device 60 which is mounted in spaced relation relative to the object of interest 11, and which further forms an image of a feature of the object of interest. The imaging device 60 forms an image signal 61 of the feature which is imaged. The invention further includes an adjustment device 40 which is mounted in force transmitting relation relative to the object of interest 11. The adjustment device 40, when actuated, imparts force to the object of interest 11 to maintain the object of interest along the course of travel 15. The invention further includes a controller 80, which is coupled in image signal receiving relation relative to the imaging device 60, and which is further disposed in controlling relation relative to the adjustment device 40. The controller 80 selectively actuates the adjustment device 40 based upon the received image signal 61 so as to maintain the object of interest 11 along the predetermined course of travel 15.

As noted above, the object of interest 11 comprises an elongated continuous conveyor belt 50 which has a longitudinal axis 56, top and bottom flights 51 and 52, respectively, and which is further tensioned between a drive roller 20, and an idler roller 30. The drive roller 20, and the idler roller 30 each are oriented in a substantially perpendicular relationship relative to the longitudinal axis 56 of the continuous conveyor belt 50. The drive roller 20 and the idler roller 30 are further selectively moveably adjustable relative to the longitudinal axis 56 of the continuous conveyor belt 50 so as to maintain the conveyor belt 50 along the predetermined course of travel 15.

The present invention 10 further includes an electromagnetic radiation emitter 70 which emits electromagnetic radiation 71 that forms, at least in part, a portion of the image generated by the imaging device 60. In the arrangement as seen in the drawings, the electromagnetic radiation 71 which is emitted can be either visible or invisible. In one form of the invention 10, as seen in the drawings, the electromagnetic radiation emitter 70 emits electromagnetic radiation 71 in a manner and where the electromagnetic radiation 71 is transmitted in a direction from the continuous conveyor belt 50, and in the direction of the imaging device 60 (FIG. 2). In another form of the invention, the electromagnetic radiation emitter 70 emits electromagnetic radiation 71 in a manner and where the electromagnetic radiation 71 is transmitted in a direction toward, and is reflected, at least in part from, the object of interest 11 (FIG. 1). In this arrangement, at least some of the reflected electromagnetic radiation 71 forms the image signal 61, and which is generated by the imaging device 60 and subsequently transmitted to the controller 80.

In the present invention 10, the adjustment device 40 further comprises a linear actuator 41, which, when rendered operational, is continuously adjustable by the action of the controller 80 so as to exert a variable and predetermined amount of force on either the drive roller 20, and/or the idler roller 30, so as to change the relative position thereof, and thus effect the movement of the continuous conveyor belt 50 along the course of travel 15. In the arrangement as seen in the drawings, the drive roller 20, and the idler roller 30 each have opposite ends. Still further the linear actuator 41 is mounted in force transmitting relation relative to one end of either of the drive roller 20, and/or the idler oiler 30. In the arrangement as seen in FIG. 4, the apparatus 10 further comprises in one form of the invention a second linear actuator 41, and which is mounted on the opposite end of either the drive roller 20 or idler roller 30. Each of the linear actuators 41 are operably coupled to the controller 80. In the arrangement as seen in the drawings, and by example, the feature which is imaged by the imaging device 60 is a peripheral edge 53 and/or 54 of the top or bottom flight 51 or 52, of the continuous conveyor belt 51. The present invention 10 further includes a load cell 45 which is coupled in force sensing relation relative to the linear actuator 41. The load cell 45 is further coupled in signal transmitting relation relative to the controller 80. The signal which is supplied to the controller 80, by the load cell 45, indicates to the controller 80 the amount of force being exerted by the linear actuator 41, on the drive roller 20 and/or idler roller 30; and the elongated continuous conveyor belt 50. In operation the electromagnetic radiation 61 may be in one form of the invention, continuously generated when the elongated conveyor belt 51 is in operation. In another possible form of the invention, electromagnetic radiation 61 may be only periodically generated when the elongated conveyor belt 50 is in operation. Those skilled in the art will recognize that the feature being imaged may comprise other items or features such as a continuous or periodic printed line which is placed in a given location where it can be imaged on either the top or bottom flight 51 or 52; or some other optically discernible feature of the continuous conveyor belt 50, and which can be imaged by the imaging device 60.

Therefore, it will be seen that the present invention 10 provides a convenient means whereby an object of interest 11, such as a conveyor belt 50, may be monitored, during operation, and then selectively adjusted in its orientation relative to a drive roller 20, and/or an idler roller 30, so as to ensure an appropriate operation of the object of interest 11 during operation.

In compliance with the statute, the invention has been described in language more or less specific as to structural and methodical features. It is to be understood, however, that the invention 10 is not limited to the specific features shown and described, since the means herein disclosed comprise preferred forms of putting the invention into effect. The invention is, therefore, claimed in any of its forms or modifications within the proper scope of the appended claims appropriately interpreted in accordance with the Doctrine of Equivalence.

We claim:

1. An apparatus for adjustably positioning an object of interest, comprising:
an object of interest which, when rendered operational, is moveable along a predetermined course of travel;
an imaging device which is mounted in spaced relation relative to the object of interest, and which forms an image of a feature of the object of interest, and wherein the imaging device forms an image signal of the feature which is imaged;
an adjustment device mounted in force transmitting relation relative to the object of interest, and wherein the adjustment device, when actuated, imparts force to the object of interest to maintain the object of interest along the course of travel; and
a controller coupled in image signal receiving relation relative to the imaging device, and which is further disposed in controlling relation relative to the adjustment device, and wherein the controller selectively actuates the adjustment device based upon the received image signal so as to maintain the movement of the object of interest along the predetermined course of travel.

2. An apparatus as claimed in claim 1, and wherein the object of interest comprises an elongated, continuous conveyor belt which has a longitudinal axis top and bottom flights, and which is further tensioned between a drive roller and an idler roller, and wherein the drive roller and the idler roller each have a longitudinal axis which is oriented in substantially perpendicular relation relative to the longitudinal axis of the continuous conveyor belt, and wherein the longitudinal axis of either the drive roller, or the idler roller, is selectively moveably adjustable relative to the longitudinal axis of the continuous conveyor belt so as to maintain the conveyor belt along the course of travel.

3. An apparatus as claimed in claim 2, and wherein the imaging device further comprises:
an electromagnetic radiation emitter which emits electromagnetic radiation which forms, at least in part, a portion of the image generated by the imaging device.

4. An apparatus as claimed in claim 3, and wherein the electromagnetic radiation which is emitted is either visible or invisible.

5. An apparatus as claimed in claim 4, and wherein the electromagnetic radiation emitter which emits electromagnetic radiation does so in a manner and where the electromagnetic radiation is transmitted in a direction from the continuous conveyor belt, and in the direction of the imaging device.

6. An apparatus as claimed in claim 4, and wherein the electromagnetic radiation emitter which emits electromagnetic radiation does so in a manner and where the electromagnetic radiation is transmitted in a direction toward, and is reflected, at least in part from, the object of interest, and wherein at least some of the reflected electromagnetic radiation forms the image generated by the imaging device.

7. An apparatus as claimed in claim 4, and wherein the adjustment device further comprises a linear actuator, which, when rendered operational, is continuously adjustable by the action of the controller so as to exert a variable amount of force on either the drive roller and/or the idler roller so as to change the relative position of the longitudinal axis thereof, and effect the movement of the continuous conveyor belt along the course of travel.

8. An apparatus as claimed in claim 7, and wherein the drive roller, and the idler roller each have opposite ends, and wherein the linear actuator is mounted in force transmitting relation relative to one end of either the drive roller and/or the idler roller.

9. An apparatus as claimed in claim 8, and wherein the apparatus further comprises a second linear actuator which is mounted on the opposite end of either the drive roller or the idler roller, and wherein each of the drive roller, and the idler roller, are operably coupled to the controller.

10. An apparatus as claimed in claim 7, and wherein the feature which is imaged by the imaging device is a peripheral edge of the top or bottom flight of the continuous conveyor belt.

11. An apparatus as claimed in claim 10, and further comprising a load cell which is coupled in force sensing relation relative to the linear actuator, and wherein the load cell is further coupled in signal transmitting relation relative to the controller, and wherein the signal which is supplied to the controller by the load cell indicates to the controller the amount of force being exerted by the linear actuator on the drive roller and/or the idler roll, and the elongated, continuous conveyor belt.

12. An apparatus as claimed in claim 11, and wherein the electromagnetic radiation is continuously generated when the continuous, elongated conveyor belt is in operation.

13. An apparatus as claimed in claim 11, and wherein the electromagnetic radiation is periodically generated when the continuous, elongated conveyor belt is in operation.

14. An apparatus for adjustably positioning an object of interest, comprising:
an elongated continuously rotatable conveyor belt which has opposite first and second ends, a top flight for supporting a product, and an opposite bottom flight, and wherein the elongated, continuously rotatable conveyor belt has a peripheral edge, and is further tensioned between a drive roller, and at least one idler roller, and further has a longitudinal axis which extends between the first and second ends thereof, and wherein the drive roller, and the at least one idler roller, each have a longitudinal axis which is located in a transverse orientation relative to the longitudinal axis of the elongated, continuously rotatable conveyor belt;
an electromagnetic radiation emitter which, when energized, emits electromagnetic radiation which is directed towards the peripheral edge of the top or bottom flight of the elongated, continuously rotatable conveyor belt;
a linear actuator mounted in force transmitting relation relative to the drive roller and/or idler roller, and wherein a force generated by the linear actuator on either of the drive roller and/or idler roller changes the orientation of the longitudinal axis of either of the drive roller and/or idler roller relative to the longitudinal axis of the elongated, continuously rotatable conveyor belt;
an imaging device which is mounted in spaced relation relative to the top or bottom flight of the elongated, continuous conveyor belt, and wherein the imaging device forms an image of the peripheral edge of the top or bottom flight from at least some of the electromagnetic radiation which is directed toward the peripheral edge by the energized electromagnetic radiation emitter, and wherein the imaging device forms an image signal which is representative of the image of the peripheral edge, and which is formed by the imaging device; and
a controller coupled in image signal receiving relation relative to the imaging device, and which is further controllably coupled with each of the linear actuator, and the electromagnetic radiation emitter, and wherein the elongated, continuous conveyor belt is moveable along a predetermined path of travel between the drive roller, and the at least one idler roller, and wherein the controller, upon sensing from the received image signal that the peripheral edge of the top or bottom flight is moving in a direction which is away from the predetermined path of travel, operably actuates the linear actuator so as to exert a predetermined amount of force on either the drive roller and/or idler roller, and wherein the force exerted on either the drive and/or idler rollers affects a change in the positional orientation of the longitudinal axis of the drive rover and/or the idler roger relative to the longitudinal axis of the elongated, continuous conveyor belt and causes a resulting motion of the elongated, continuous conveyor belt in a direction back to the predetermined path of travel.

15. An apparatus as claimed in claim 14, and wherein the electromagnetic radiation which is emitted is either visible or invisible.

16. An apparatus as claimed in claim 14, and wherein the electromagnetic radiation emitter which emits the electromagnetic radiation does so in a manner and where the electromagnetic radiation is transmitted in a direction from the continuous conveyor belt, and in the direction of the imaging device.

17. An apparatus as claimed in claim 4, and wherein the electromagnetic radiation emitter which emits electromagnetic radiation does so in a manner and where the electromagnetic radiation is transmitted in a direction toward, and is reflected, at least in part from, the top or bottom flight of the elongated, continuously rotatable conveyor belt, and wherein at least some of the reflected electromagnetic radiation forms the image generated by the imaging device.

18. An apparatus as claimed in claim 14, and wherein the drive roller, and the idler roller each have opposite ends, and wherein the linear actuator is mounted in force transmitting relation relative to one end of either the drive roller and/or the idler roller, and wherein the force applied by the linear actuator to one end of either the drive roller and/or the idler roller moves the longitudinal axis thereof in a given plane which has a predetermined angular orientation relative to the top flight of the elongated, continuously rotatable conveyor bed.

19. An apparatus as claimed in claim 14, and further comprising a load cell which is coupled in force sensing relation relative to the linear actuator, and wherein the load cell is coupled in signal transmitting relation relative to the controller, and wherein the signal which is supplied to the controller by the load cell indicates to the controller the amount of force being exerted by the linear actuator on the drive roller, and/or the idler roll, and the elongated, continuously rotatable conveyor belt.

20. An apparatus as claimed in claimed in claim 14, and wherein the electromagnetic radiation is continuously generated when the elongated, continuously rotatable conveyor belt is in operation.

21. An apparatus as claimed in claim 14, and wherein the electromagnetic radiation is periodically generated when the elongated, continuously rotatable conveyor belt is in operation.
